(19) United States
(12) Patent Application Publication
(10) Pub. No.: US 2014/0222929 A1
(43) Pub. Date: Aug. 7, 2014

(54) System, Method And Device For Creation And Notification Of Contextual Messages

(71) Applicant: Brent Grossman, Seattle, WA (US)

(72) Inventor: Brent Grossman, Seattle, WA (US)

(21) Appl. No.: 13/761,122

(22) Filed: Feb. 6, 2013

(51) Int. Cl. H04L 12/58

(52) U.S. Cl. CPC H04L 51/20
USPC 709/206

(57) ABSTRACT

System, method and device for the creation and notification of contextual messages are described. When creating or authoring a message, a sender can define a context in which the message is to be delivered to a recipient. Accordingly, after receiving the message, the recipient's device does not notify the recipient of the receipt of the message until the context is fulfilled. The recipient's device monitors conditions and determines whether the context is fulfilled, and notifies the recipient of the receipt of the message when the context is fulfilled. The recipient can configure common locations associated with the recipient and the information thereof is available in a non-specific way to a message sender for defining the context.

### BACKGROUND

1. Technical Field

The present disclosure relates to messaging. More specifically, the present disclosure relates to contextual messaging.

2. Description of Related Art

In general, messaging refers to the creation, storage, management and delivery of human-perceivable messages over a communications network. Typically, users of two or more portable devices, such as mobile phones, create and send a brief, electronic message to one or more other users over a communications network. The messages may be purely text messages, but may also include image, video and/or audio content.

When a message is received by a recipient's device from a sender's device, typically a certain action on the recipient's device is triggered (e.g., a beeping sound, ring or tone, vibration of the device, a visual notification on screen, or a combination thereof) to notify the recipient that a message has been received. In some cases, the recipient's device may automatically proceed to deliver the message to the recipient (e.g., displaying the text, image and/or video, or playing the audio content) without any action on the part of the recipient. However, there are times and places when/where it is inconvenient for the recipient to receive the message. For example, a person carrying a portable device that is capable of receiving messages may not wish to receive a message when in a library, at a church, resting, driving, and so forth—or perhaps the message simply isn't very applicable to them in their current context.

Presently there are some techniques that give certain control to a would-be recipient of messages to establish one or more conditions under which messages can or cannot be delivered to the recipient by the recipient's portable device. For example, some portable devices are operable in a so-called “Do Not Disturb” mode which relies on the recipient to manually update the recipient's context under which messages are not to be delivered to the recipient by the device. Or, with geo-fencing, a recipient can define a locational context in which the recipient's device can notify the recipient of received messages and present messages to the user/recipient. On the other hand, some portable devices capable of text messaging do not have the functionality to allow the recipient of messages to define any context under which messages are to be delivered.

### SUMMARY

System, method and device for the creation and notification of contextual messages are described. When creating or authoring a message, a sender can define a context in which the message is to be delivered to a recipient. Accordingly, after receiving the message, the recipient's device does not notify the recipient of the receipt of the message until the context is fulfilled. The recipient's device monitors conditions and determines whether the context is fulfilled, and notifies the recipient of the receipt of the message when the context is fulfilled. The recipient can configure common locations associated with the recipient and the information thereof is available to a message sender for defining the context.

According to one aspect, a method related to creation and notification of contextual messages may comprise: receiving locational context information related to a first user; presenting the locational context information related to the first user to a second user; receiving input from the second user to create a message to the first user according to the input; receiving at least one contextual condition from the second user, the at least one contextual condition defining one or more conditions to be fulfilled in order for the message to be presented to the first user by a first device operated by the first user; and transmitting the message along with the at least one contextual condition to the first device.

In one embodiment, the locational context information related to the first user may comprise a plurality of categories of locations associated with the first user.

In one embodiment, the at least one contextual condition may be derived from the locational context information related to the first user.

In one embodiment, the at least one contextual condition may comprise a time of day, an event, a location, or a combination thereof.

In one embodiment, the at least one contextual condition may comprise a location defined by a geographic point and a radius around the geographic point.

In one embodiment, the at least one contextual condition may further comprise a minimum duration for which the first device needs to be within the radius around the geographic point in order for the first device to present the message to the first user.

In one embodiment, the message may comprise text, image, video data, audio data, or a combination thereof.

In one embodiment, receiving locational context information related to a first user may comprise receiving a label representative of a location associated with the first user from a server where locational information entered by the first user is stored.

In one embodiment, the first user may be the second user, and the message may comprise a self-reminder for the first user.

According to another aspect, a computer-readable storage medium storing computer-executable instructions that, when executed by one or more processors, may perform operations that comprise: receiving user information of a first user from a first device operated by the first user, the user information comprising a name of the first user, a user identification (ID) of the first user, a phone number of the first user, locational context information related to the first user, or a combination thereof; storing the user information of the first user; and providing data indicative of at least part of the user information of the first user to a second device operated by a second user.

In one embodiment, the locational context information related to the first user may comprise a plurality of categories of locations associated with the first user.

In one embodiment, providing data indicative of at least part of the user information of the first user to a second device operated by a second user may comprise providing the locational context information related to the first user to the second device operated by the second user.

In one embodiment, the operations may further comprise: receiving, from the second device, a request for information related to the first user. Providing data may comprise providing the data in response to receiving the request.

According to yet another aspect, a device may comprise: a memory unit, a communication unit, a user interface unit, and a processor. The memory unit may be configured to store one or more sets of instructions. The communication unit may be configured to transmit and receive data including messages. The user interface unit may be configured to receive input form a first user and present information to the first user. The processor may be coupled to the memory unit, the communication unit and the user interface unit. The processor may be configured to execute the one or more sets of instructions and perform operations comprising: receiving, through the communication unit, a message from a device operated by a second user, the message including at least one contextual condition defined by the second user; determining whether the at least one contextual condition is fulfilled; and providing, through the user interface unit, an indication to the first user to indicate receipt of the message in response to determining the at least one contextual condition is fulfilled.

In one embodiment, the at least one contextual condition may comprise a time of day, an event, a location, or a combination thereof.

In one embodiment, the at least one contextual condition may comprise a location defined by a geographic point and a radius around the geographic point within which the device needs to be in order for the at least one contextual condition to be fulfilled.

In one embodiment, the at least one contextual condition may further comprise a minimum duration for which the device needs to be within the radius around the geographic point in order for the at least one contextual condition to be fulfilled.

In one embodiment, the message may comprise text, image, video data, audio data, or a combination thereof.

In one embodiment, the processor may be further configured to perform operations comprising: receiving, through the user interface unit, user information of the first user, the user information comprising a name of the first user, a user ID of the first user, a phone number of the first user, locational context information related to the first user, or a combination thereof; and transmitting, through the communication unit, the user information to a server.

In one embodiment, the device may further comprise a location determination unit configured to determine an approximate geographic location of the device and output locational data indicative of the approximate geographic location of the device. The processor may be configured to determine whether the at least one contextual condition is fulfilled using the locational data.

These and other objectives of the present disclosure will be appreciated by those of ordinary skill in the art after reading the following detailed description of the preferred embodiments that are illustrated in the drawings of the present disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is an example architecture for creation and notification of contextual messages in accordance with an embodiment of the present disclosure.

FIG. 2 is a flow diagram of an example process related to creation and notification of contextual messages in accordance with an embodiment of the present disclosure.

FIG. 3 is a flow diagram of an example process related to creation and notification of contextual messages in accordance with another embodiment of the present disclosure.

FIG. 4 is a flow diagram of an example process related to creation and notification of contextual messages in accordance with yet another embodiment of the present disclosure.

FIG. 5 is a block diagram of an example device that may be used to perform creation and notification of contextual messages in accordance with the present disclosure.

### DETAILED DESCRIPTION OF PREFERRED EMBODIMENTS

### Overview

The present disclosure pertains to techniques, systems, methods and devices for creation and notification of contextual messages. According to the present disclosure, the burden of defining the context in which a recipient of a message is to be notified of the receipt of the message is shifted from the recipient to the sender of the message. One advantage of doing so is that a message recipient would not be forced to continuously update his/her ‘geo-fences’ or availability as the burden is shifted to the message sender.

When creating or authoring a message, a sender can define a context in which the message is to be delivered to a recipient. Accordingly, after receiving the message, the recipient's device does not notify the recipient of the receipt of the message until the context is fulfilled. A context can be a combination of Recipient+Time, Location and/or Event. The recipient's device monitors conditions and determines whether the context is fulfilled, and notifies the recipient of the receipt of the message when the context is fulfilled. Alternatively, in some scenarios such as in a Time+Location context for example, it may be the sender's device that waits for the time context to be fulfilled and then sends off the message (which, at such time, may contain the remaining location context). This allows the sender to cancel a message, for one reason or another, prior to the fulfillment of the time context.

According to the proposed technique of the present disclosure, contexts, or contextual conditions, to be fulfilled are not limited to the recipient's side of the communication but may be defined such that the fulfillment takes place on the sender's side or both sides. For example, the sender may define a first context that requires the sender (or the sender's device) to be in the vicinity of the recipient's home in order for the message to be sent to the recipient, and a second context that requires the recipient (or the recipient's device) to be in the recipient's home in order for the recipient's device to present the message to the recipient. That is, the fulfillment of the first context takes place on the sender's side and the fulfillment of the second context takes place on the recipient's side. As an alternative example, the sender may define just one context which requires the sender (or the sender's device) to be in the vicinity of the recipient's home in order for the message to be sent to the recipient. In this case, the fulfillment of the context takes place on the sender's side.

The recipient can configure common locations associated with the recipient (e.g., home, work, school, grocery store, etc.) and the information thereof is available, in a non-specific way, to a message sender for defining the context. That is, the sender may receive and see a respective label, or tag, that is a generalized representation of each of a number of locations associated with the recipient instead of actual names of specific places associated with the recipient (including places where the recipient has been and/or places where the recipient has not been). For example, rather than receiving and seeing “parents' house” or “Whole Foods”, the sender may see the more generic label of “home” or “grocery store”, respectively. One advantage of doing so is that the need for the message sender to know any specific/private information about the message recipient is eliminated. To the message recipient this beneficial at least in terms of privacy. In short, the message sender can send a contextual message without knowing everything about the recipient, and the recipient is notified about the message within the desired context—all by leveraging the existing texting infrastructure.

### Illustrative Architecture for Creation and Notification of Contextual Messages

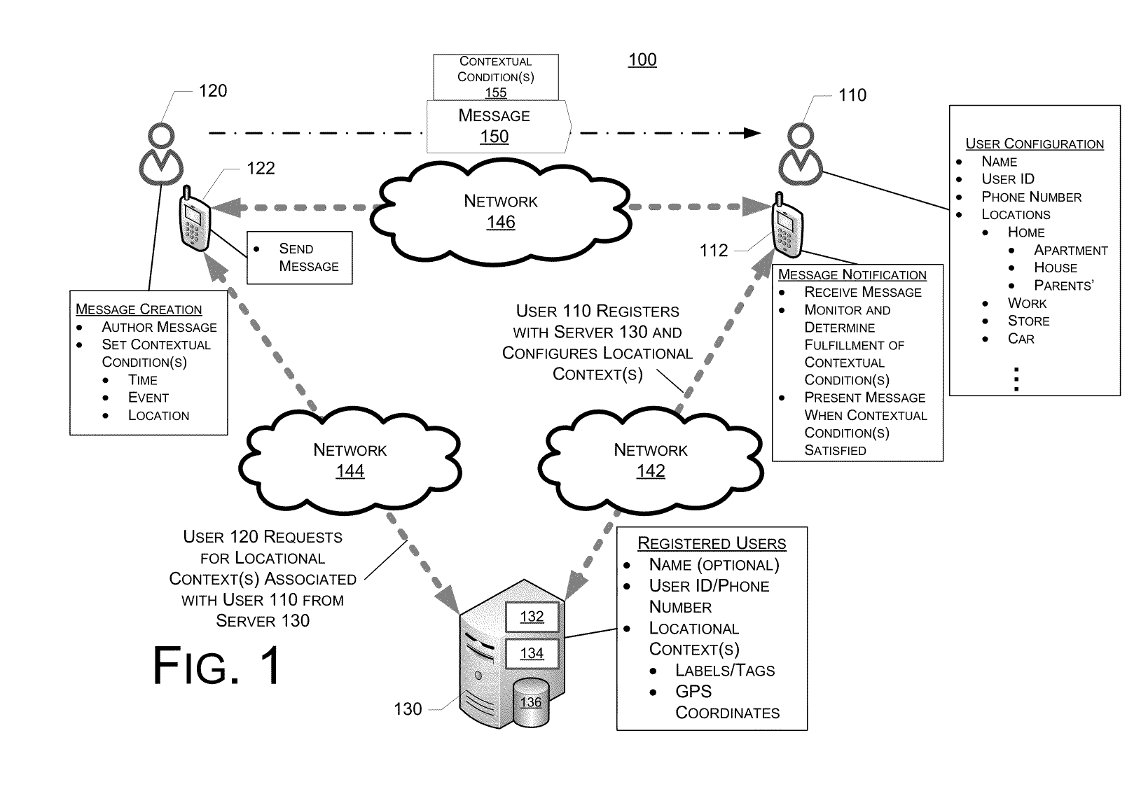

FIG. 1 illustrates an example architecture 100 for creation and notification of contextual messages in accordance with an embodiment of the present disclosure.

The architecture 100 comprises at least a first user 110 who operates a first device 112, a second user 120 who operates a second device 122, and a server 130. In the architecture 100, the first user 110 is a recipient of a contextual message 150 created and sent by the second user 120 via the second device 122. Each of the first device 112 and the second device 122 may be a portable device such as, for example, a smartphone, a mobile phone, a personal digital assistant, a tablet computer, a laptop computer, a notebook computer or the like. Each of the first device 112 and the second device 122 may be capable of communicating wirelessly and/or via a wire-line medium such as Ethernet, coaxial cable, phone line and/or power line.

As shown in FIG. 1, the first device 112 and server 130 communicate with one another over network 142. The second device 122 and server 130 communicate with one another over network 144. The first device 112 and the second device 122 communicate with one another over network 146. In one embodiment, each of the networks 142, 144 and 146 may be, for example, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN) or the Internet. In another embodiment, at least a portion of the communication path between the first device 112, the second device 122 and server 130 may be in accordance with one or more wireless standards such as, for example, IEEE 802.11 standards, WiFi, Bluetooth, infrared, WiMax, Long Term Evolution (LTE) and/or future versions and/or derivatives thereof. Alternatively, networks 142, 144 and 146 may be substituted by a single network or multiple networks. Networks 142, 144 and 146 may comprise a combination of wireless and wire-line networks.

Server 130 comprises at least a processor 132 and a memory unit 134. The processor 132 can execute one or more sets of instructions stored in the memory unit 134. The memory unit 134 may be, for example, volatile memory such as random access memory (RAM), non-volatile memory such as read-only memory (ROM), electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the processor 132. Server 130 further comprises a database 136 in which user configuration information of registered users, such as the first and second users 110 and 120, is stored.

The first user 110 enters user configuration information about himself or herself through the first device 112 which forwards such information to server 130 via network 142. Of course, although FIG. 1 illustrates the first device 112 as the device being used, the first user 110 may enter user configuration information through any other suitable device such as, for example, a desktop or laptop computer, through a web interface or the like on that device. Similarly, techniques of the present disclosure may be achieved when the first user 110 receives and sends messages using any other suitable device, not just through the first device 112. User configuration information may include, for example, the name, user ID, phone number and common locations associated with a user. In one embodiment, the name may be optional and not stored in server 130, and user-unique identifier such as the user's phone number or user ID is stored in server 130.

In one embodiment, the first user 110 may enter locational contexts as locations frequented by him or her such as home, work, shop, bank, etc. The locational contexts may be generally categorized such as, for instance, labels or tags like “public place” and “private place”, or “home”, “work”, “store” and so on. The locational contexts may be sub-categorized as well. Take “home” as an example, under the “home” category, the first user 110 can enter “apartment”, “house” or “parents' home” to be more specific. Similarly, under the “store” category, the first user 110 can enter “mall”, “grocery store” or “supermarket” to be more specific. Further, for example, under “grocery store” the first user can enter “Whole Foods”, “Safeway”, “Albertsons” or the like to be even more specific. The sub-categorization applies to all general categories but, in the interest of brevity, a detailed listing of possible sub-categories is not provided herewith.

The locational contexts of the first user 110 (or, to be precise, the location of the first device 112, or any other suitable device in a general sense) may be updated automatically if the first device 112 is equipped with location determining means such as, for example, a global positioning system (GPS) unit. In such case the first user 110 may first correlate the common locations associated with the first user 110 approximately with respective metes and bounds in terms of longitude and latitude. Such correlation may be stored in the first device 112 and/or server 130. Then, when the first device 112 determines the location of the first device 112 (and presumably the location of the first user 110 as well) at any given time, the first device 112 transmits information related to the location to server 130 which in turn uses the correlation to determine which location (e.g., home, work or store) the first device 112 (and presumably the first user 110) is currently at. Of course, such correlation may be performed by the first device 112 and transmits the determined location (e.g., home, work or store) to server 130 to update the current location of the first device 112 (and presumably the location of the first user 110).

Alternatively, the first device 112 may update and store the determined location as the current location of the first device 112, without needing to transmit such data to server 130 for storage there. That is, in one embodiment, most if not all the necessary information to carry out the proposed technique of the present disclosure on the recipient's side may be stored in the first device 112 and not in server 130. The locational contexts may be stored either on server 130 in the form of labels/tags or actual GPS coordinates.

Server 130 receives user configuration information of registered users, including the user configuration information of the first user 110 received from the first device 112 via network 142, and stores the information in database 136. In other words, the database 136 of server 130 maintains a roster of all registered users and includes information of each registered user such as, for example, name, user ID, phone number and one or more locational contexts.

As the locational contexts of the first user 110 stored in server 130 are accessible by the second user 120 via the second device 122, the locational contexts stored in server 130 may be a direct reflection of the locations entered by each registered user. Alternatively, the locational contexts stored in server 130 may be a generalized representation of the locations entered by each registered user. For example, server 130 may store “apartment” as a locational context for the first user 110 after the first user 110 has entered “apartment” as a location. As another example, server 130 may store “home” as a locational context for the first user 110 after the first user 110 has entered “apartment” as a location.

When creating or authoring message 150 addressed to the first user 110, the second user 120 defines one or more contextual conditions 155 to be fulfilled in order for the first user 110 to be notified of and view/hear the message 150. The second device 122 may display to the second user 120 a menu showing available options of contextual conditions including, for example, time, event and/or one or more locations. The contextual condition in terms of time may be a specific time of a chosen date. Additionally or alternatively, the contextual condition in terms of time may be a specific duration for which the event and/or locational context(s) need to be fulfilled in order for the first user 110 to be notified of the receipt of message 150. The contextual condition in terms of event may be a specific event such as, for example, power-on or power-off of the first device 112 (as the first user 110 is the intended recipient of message 150), launch of a specific application on the first device 112, movement or non-movement sensed by the first device 112 (e.g., in case the first device 112 is equipped with gyroscope and/or accelerometer), the occurrence or onset of one or more event. The occurrence or onset of one or more event may be detected or determined by the first user 110, an application or service (e.g., Twitter, RSS feed, etc.). For example, a person who wants to send a message to his friend when a particular sports team wins a particular game may set the winning of the particular game by the particular team as the contextual condition in terms of event. If the particular team ends up not winning the particular game, the person's friend will not receive the message and the person would be spared any embarrassment stemming therefrom. The contextual condition in terms of location may be one or more of the location contexts associated with the first user 110 as made available by server 130. Additionally or alternatively, the contextual condition in terms of location may be a user-defined condition such as, for example, an area within a user-defined radius (e.g., in feet or meters) around a user-defined geographic point (e.g., in longitudinal and latitudinal coordinates).

After the message 150 is created and one or more contextual conditions 155 defined, the second user 120 instructs the second device 122 to transmit or send the message 150 along with the one or more contextual conditions 155 to the first device 112 over network 146. The one or more contextual conditions 155 may require fulfillment on the recipient's side, the sender's side, or both.

The first device 112 receives the message 150 and the one or more contextual conditions 155 from the second device 122 over network 146. Rather than immediately notifying the first user 110 of the receipt of the message 150, the first device 112 determines whether the one or more contextual conditions 155 is/are fulfilled. If the first device 112 determines the one or more contextual conditions 155 is/are fulfilled, the first device 112 indicates to the first user 110 (e.g., via a sound/tone/ring, a vibration, a visual notification, or a combination thereof) that the message 150 has been received. Otherwise, if the first device 112 determines the one or more contextual conditions 155 is/are not fulfilled, the first device 112 does not notify the first user 110 and continues to monitor conditions and determine whether the one or more contextual conditions 155 is/are fulfilled. Once the one or more contextual conditions 155 is/are fulfilled, the first device 112 presents the message 150 to the first user 110 through a user interface (e.g., display panel or screen, speaker, or a combination thereof) of the first device 112.

The first device 112 may display a list of pending messages for which respective contextual conditions are not yet fulfilled. This enables the first user 110 to see what message(s) may be waiting for him/her and decide whether or not to read and/or hear such message(s) (e.g., by manual override or otherwise instructing the first device 112 to present such message(s) unconditionally according to commands from the first user 110).

### Example Processes

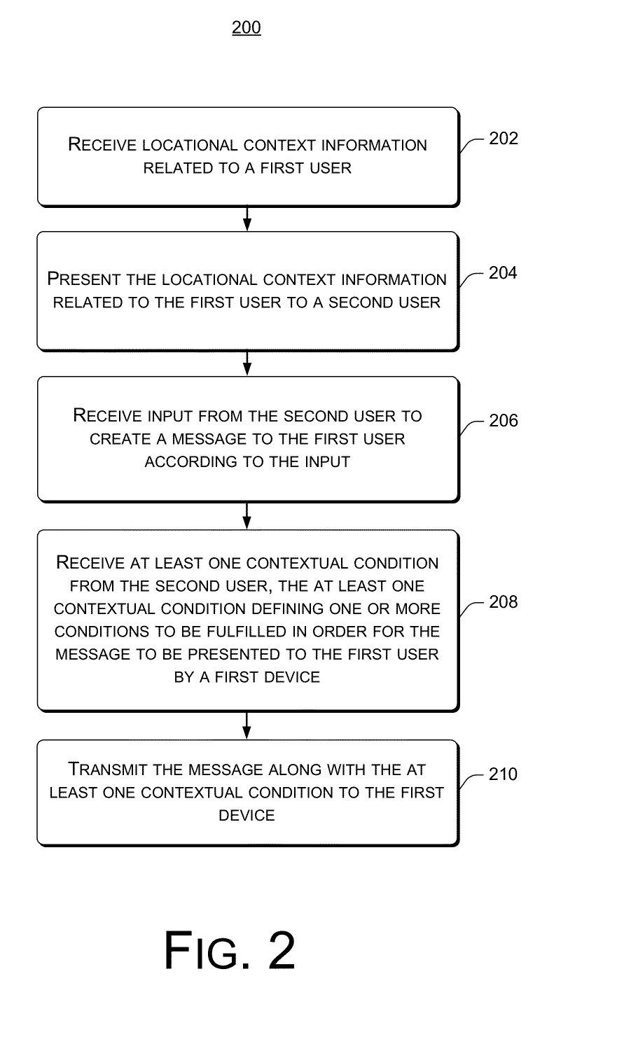

FIG. 2 illustrates an example process 200 related to creation and notification of contextual messages in accordance with an embodiment of the present disclosure.

Example process 200 includes one or more operations, actions, or functions as illustrated by one or more of blocks 202, 204, 206, 208 and 210. Although illustrated as discrete blocks, various blocks may be divided into additional blocks, combined into fewer blocks, or eliminated, depending on the desired implementation. Further, process 200 may be implemented by software, hardware, or a combination of software and hardware in any type of computing device, such as example device 500 to be described below. For illustrative purposes, the operations described below are performed by a processor of the portable device 122 operated by user 120 as shown in FIG. 1. Process 200 may begin at block 202.

At 202, the processor may receive locational context information related to a first user. For example, the processor of portable device 122 receives locational context information related to the first user 110 from server 130 via network 144.

The locational context information related to the first user may comprise a plurality of categories of locations associated with the first user. For example, the locational context information can include categories such as home, work, school, grocery store, etc. These categories may be common places frequented by and associated with the first user 110, or places that the user has never been. In one embodiment, the locational context information may be set by using ‘tags’ of the first user 110, including places where the first user 110 has yet to visit (e.g., London, Eiffel Tower or some other coordinate).

At 204, the processor may present the locational context information related to the first user to a second user. For example, the processor of portable device 122 presents the location context information related to user 110 to user 120.

At 206, the processor may receive input from the second user to create a message to the first user according to the input. For example, the processor of portable device 122 receives input from user 120 to create message 150, to be sent to user 110, according to the input.

At 208, the processor may receive at least one contextual condition from the second user. The at least one contextual condition defines one or more conditions to be fulfilled in order for the message to be presented to the first user by a first device operated by the first user. For example, the processor of portable device 122 receives at least one contextual condition 155 from user 120.

The at least one contextual condition may be derived from the locational context information related to the first user. For example, when the first user 110 enters “parents' house” as a common location associated with the first user 110, the corresponding contextual condition in terms of location may be “home” as a generalized categorization of “parent's house”.

The at least one contextual condition may comprise a time of day, an event, a location, or a combination thereof. For example, the contextual condition may be “after 6:00 PM” for time and “home” for location. As such, the first device 112 would notify the first user 110 about the receipt of message 150 when the first user 110 is at “home” (whether it is his apartment or his parents' house) after 6:00 PM.

The at least one contextual condition may comprise a location defined by a geographic point and a radius around the geographic point. For example, the contextual condition in terms of location may be a user-defined condition such as, for example, an area within a user-defined radius (e.g., in feet or meters) around a user-defined geographic point (e.g., in longitudinal and latitudinal coordinates).

The at least one contextual condition may further comprise a minimum duration for which the first device needs to be within the radius around the geographic point in order for the first device to present the message to the first user. For example, the contextual condition in terms of location may require that the first user 110 (or the first device 112) to be within a certain area for a specific amount of time in order for the first device 112 to notify the first user 110 about the receipt of message 150. This may be useful in cases when the first user 110 may be traveling past a particular location and not staying there, while the second user 120 intends the first user 110 to be notified of the receipt of message 150 when the first user 110 is staying within that particular location.

At 210, the processor may transmit the message along with the at least one contextual condition to the first device. For example, the processor of portable device 122 transmits message 150 along with the at least one contextual condition 155 to portable device 112 via network 146.

The message may comprise text, image, video data, audio data, or a combination thereof. For example, message 150 may be a text message. Additionally, message 150 may be a message including text and one or more other forms of data such as image, video and/or audio data. Alternatively, message 150 may be a message including and one or more other forms of data other than text such as image, video and/or audio data.

The information related to a location of the first user may be received from a server where locational information entered by the first user is stored. For example, information related to a location of user 110 is received by the processor of portable device 122 from server 130 via network 144.

In some occasions, the first user may be the second user, and the message may comprise a self-reminder for the first user. For example, user 120 can create and send a self-reminder message which portable device 122 will present to user 120 when the one or more contextual condition(s) associated with such self-reminder message is fulfilled.

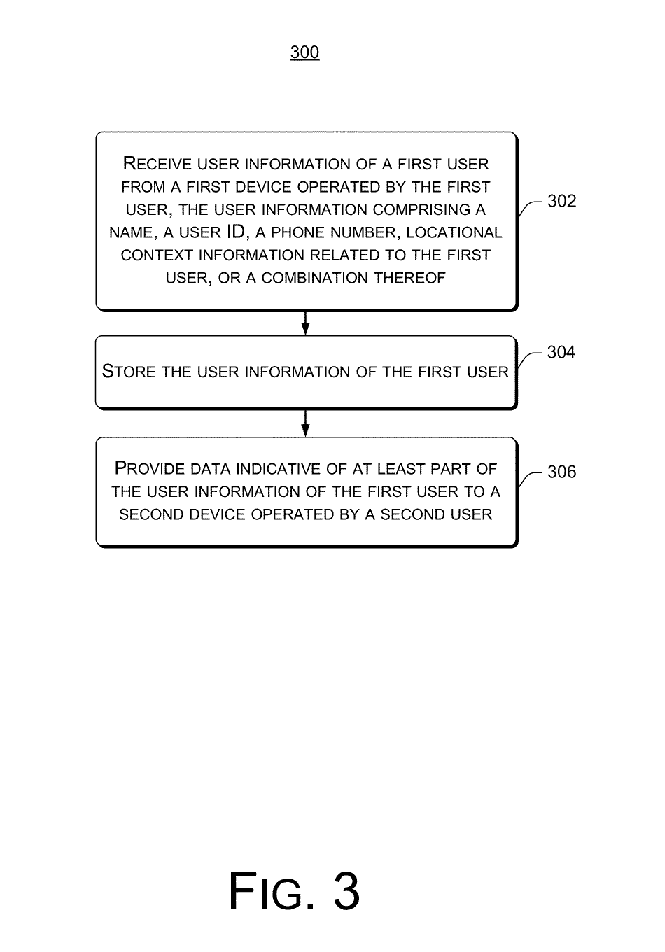

FIG. 3 illustrates an example process 300 related to creation and notification of contextual messages in accordance with another embodiment of the present disclosure.

Example process 300 includes one or more operations, actions, or functions as illustrated by one or more of blocks 302, 304 and 306. Although illustrated as discrete blocks, various blocks may be divided into additional blocks, combined into fewer blocks, or eliminated, depending on the desired implementation. Further, process 300 may be implemented by software, hardware, or a combination of software and hardware in any type of computing device, such as example device 500 to be described below. For illustrative purposes, the operations described below are performed by the processor 132 of the server 130 as shown in FIG. 1. Process 300 may begin at block 302.

At 302, the processor 132 may receive user information of a first user from a first device operated by the first user. The user information may comprise a name of the first user, a user ID of the first user, a phone number of the first user, locational context information related to the first user, or a combination thereof.

At 304, the processor 132 may store the user information of the first user. For example, the processor 132 may store the user information of the first user 110 in database 136.

At 306, the processor 132 may provide data indicative of at least part of the user information of the first user to a second device operated by a second user. For example, the processor 132 may provide only information about contextual location(s) of the first user 110 to the second device 122, and indicate “home” instead of “parents' house” or GPS coordinates as the location. The processor 132 may receive from the second device a request for information related to the first user, and provide data to the second device in response to receiving such request.

The locational context information related to the first user may comprise a plurality of categories of locations associated with the first user. For example, the locational context information can include categories such as home, work, school, grocery store, etc. These categories may be common places frequented by and associated with the first user 110.

When providing data indicative of at least part of the user information of the first user to a second device operated by a second user, the processor 132 may provide the locational context information related to the first user to the second device operated by the second user.

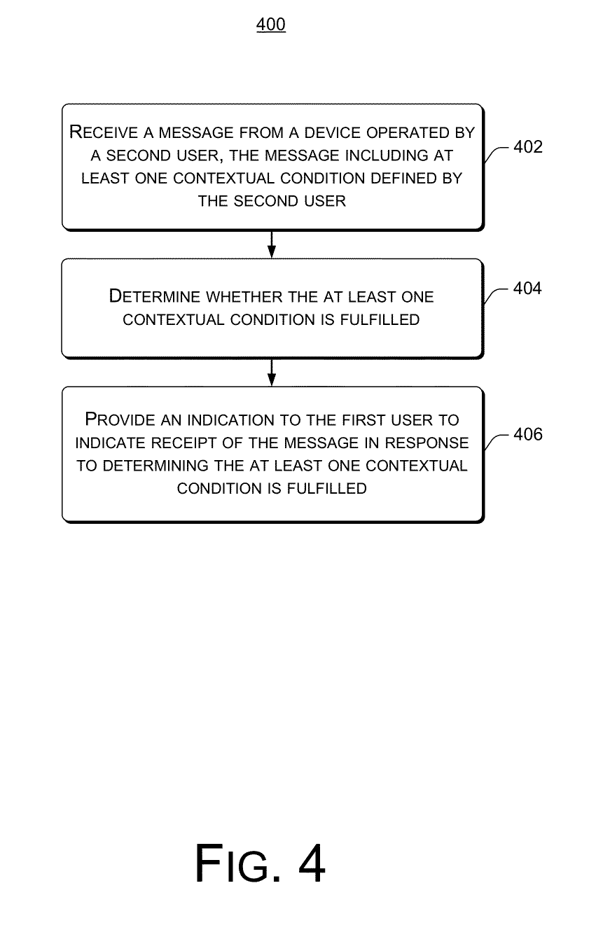

FIG. 4 illustrates an example process 400 related to creation and notification of contextual messages in accordance with yet another embodiment of the present disclosure.

Example process 400 includes one or more operations, actions, or functions as illustrated by one or more of blocks 402, 404 and 406. Although illustrated as discrete blocks, various blocks may be divided into additional blocks, combined into fewer blocks, or eliminated, depending on the desired implementation. Further, process 400 may be implemented by software, hardware, or a combination of software and hardware in any type of computing device, such as example device 500 to be described below. For illustrative purposes, the operations described below are performed by a processor of the portable device 112 operated by user 110 as shown in FIG. 1. Process 400 may begin at block 402.

At 402, the processor may receive a message from a device operated by a second user. The message may include at least one contextual condition defined by the second user.

At 404, the processor may determine whether the at least one contextual condition is fulfilled.

At 406, the processor may provide an indication to the first user to indicate receipt of the message in response to determining the at least one contextual condition is fulfilled.

The at least one contextual condition may comprise a time of day, an event, a location, or a combination thereof. For example, the contextual condition may be “after 6:00 PM” for time and “home” for location. As such, the first device 112 would notify the first user 110 about the receipt of message 150 when the first user 110 is at “home” (whether it is his apartment or his parents' house, or even both) after 6:00 PM.

The at least one contextual condition may comprise a location defined by a geographic point and a radius around the geographic point. For example, the contextual condition in terms of location may be a user-defined condition such as, for example, an area within a user-defined radius (e.g., in feet or meters) around a user-defined geographic point (e.g., in longitudinal and latitudinal coordinates).

The at least one contextual condition may further comprise a minimum duration for which the first device needs to be within the radius around the geographic point in order for the first device to present the message to the first user. For example, the contextual condition in terms of location may require that the first user 110 (or the first device 112) to be within a certain area for a specific amount of time in order for the first device 112 to notify the first user 110 about the receipt of message 150. This may be useful in cases when the first user 110 may be traveling past a particular location and not staying there, while the second user 120 intends the first user 110 to be notified of the receipt of message 150 when the first user 110 is staying within that particular location.

The message may comprise text, image, video data, audio data, or a combination thereof. For example, message 150 may be a text message. Additionally, message 150 may be a message including text and one or more other forms of data such as image, video and/or audio data. Alternatively, message 150 may be a message including and one or more other forms of data other than text such as image, video and/or audio data.

In one embodiment, the processor may further receive user information of the first user. The user information may comprise a name of the first user, a user ID of the first user, a phone number of the first user, locational context information related to the first user, or a combination thereof. The processor may additionally transmit the user information to a server. For example, the first device 112 may receive the user configuration information from the first user 110 and transmit such information to server 130.

The device may further comprise a location determination unit configured to determine an approximate geographic location of the device and output locational data indicative of the approximate geographic location of the device. The processor may be configured to determine whether the at least one contextual condition is fulfilled using the locational data. For example, the first device 112 may further include a GPS unit that aids the processor of the first device 112 in determining whether the one or more contextual conditions 155 is/are fulfilled in terms of location.

### Example Device

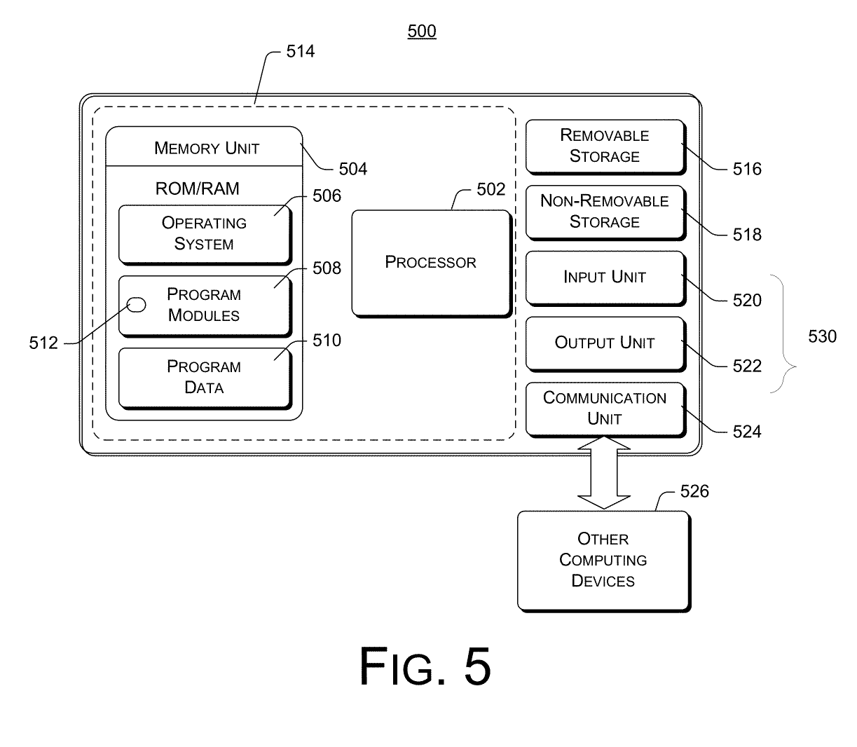

FIG. 5 illustrates an example device 500 that may implement the techniques for creation and notification of contextual messages. However, it will be readily appreciated that the techniques disclosed herein may be implemented in other devices, systems, and environments. The device 500 shown in FIG. 5 is only one example of a computing device and is not intended to suggest any limitation as to the scope of use or functionality of the computer and network architectures.

The device 500 may be a portable device such as, for example, a smartphone, a mobile phone, a personal digital assistant, a tablet computer, a laptop computer, a notebook computer or the like. Alternatively, device 500 may be a personal computer, a workstation computer, a server, a mainframe computer, etc.

In at least one configuration, device 500 typically includes at least one processor 502 and memory unit 504. Depending on the exact configuration and type of device 500, memory unit 504 may be volatile (such as RAM), non-volatile (such as ROM, flash memory, etc.) or some combination thereof. Memory unit 504 may include an operating system 506, one or more program modules 508, and may include program data 510. Device 500 is of a very basic configuration demarcated by a dashed line 514. Again, a terminal may have fewer components but may interact with a computing device that may have such a basic configuration.

In one embodiment, the program module 508 includes a contextual message creation and notification module 512. The contextual message creation and notification module 512 can carry out one or more functionalities and processes as described above with reference to FIGS. 1-4. For example, when the contextual message creation and notification module 512 is properly configured, device 500 may carry out the operations of process 200 of FIG. 2, process 300 of FIG. 3, process 400 of FIG. 4, and variations thereof.

Device 500 may have additional features or functionality. For example, device 500 may also include additional data storage devices (removable and/or non-removable) such as, for example, magnetic disks, optical disks, or tape. Such additional storage is illustrated in FIG. 5 by removable storage 516 and non-removable storage 518. Computer storage media may include volatile and nonvolatile, removable and non-removable media implemented in any method or technology for storage of information, such as computer readable instructions, data structures, program modules, or other data. Memory unit 504, removable storage 516 and non-removable storage 518 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 500. Any such computer-readable storage media may be part of the computing device 500. Device 500 may also have user interface unit 530 which includes input unit 520 and output unit 522. Input unit 520 may include, for example, keyboard, mouse, pen, voice input device, touch input device, or a combination thereof. Output unit 522 may include, for example, a display, speakers, printer, or a combination thereof.

Device 500 may also include communication unit 524 that allow the device to communicate with other computing devices 526, such as over a network. These networks may include wired networks as well as wireless networks.

Other well-known computing devices, systems, environments and/or configurations that may be suitable for use with the embodiments include, but are not limited to personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, and/or the like.

### CONCLUSION

In summary, the present disclosure provides a system, method and device for the creation and notification of contextual messages. Benefits offered by the disclosed system, method and device are numerous. One advantage is that a message recipient would not be forced to continuously update his/her ‘geo-fences’ or availability as the burden is shifted to the message sender. Another advantage is that the need for the message sender to know any specific/private information about the message recipient is eliminated. To the message recipient this beneficial at least in terms of privacy. In summary, the message sender can send a contextual message without knowing everything about the recipient, and the recipient is notified about the message within the desired context. Embodiments of the present disclosure can be implemented by leveraging the existing texting infrastructure.

It is specifically contemplated that any feature disclosed herein with respect to one embodiment or one figure of the present disclosure may apply to any other embodiment of the present disclosure. More specifically, although any given feature may be described above in connection with one or more particular embodiments or figures, such feature may be applied in any combination with any other feature with respect to all other embodiments and figures, and variations thereof, without departing from the spirit of the present disclosure and so long as such feature does not contradict with one or more features of the other embodiments and figures.

Although a number of embodiments of the present disclosure are described above, the scope of the present disclosure is not and cannot be limited to the disclosed embodiments. More specifically, one ordinarily skilled in the art may make various deviations and improvements based on the disclosed embodiments, and such deviations and improvements are still within the scope of the present disclosure. Accordingly, the scope of protection of a patent issued from the present disclosure is determined by the claims provided below.

What is claimed is:

1. A method related to creation and notification of contextual messages, the method comprising:
receiving locational context information related to a first user;
presenting the locational context information related to the first user to a second user;
receiving input from the second user to create a message to the first user according to the input;
receiving at least one contextual condition from the second user, the at least one contextual condition defining one or more conditions to be fulfilled in order for the message to be presented to the first user by a first device operated by the first user; and
transmitting the message along with the at least one contextual condition to the first device.

2. The method of claim 1, wherein the locational context information related to the first user comprises a plurality of categories of locations associated with the first user.

3. The method of claim 1, wherein the at least one contextual condition is derived from the locational context information related to the first user.

4. The method of claim 1, wherein the at least one contextual condition comprises a time of day, an event, a location, or a combination thereof.

5. The method of claim 1, wherein the at least one contextual condition comprises a location defined by a geographic point and a radius around the geographic point.

6. The method of claim 5, wherein the at least one contextual condition further comprises a minimum duration for which the first device needs to be within the radius around the geographic point in order for the first device to present the message to the first user.

7. The method of claim 1, wherein the message comprises text, image, video data, audio data, or a combination thereof.

8. The method of claim 1, wherein receiving locational context information related to a first user comprises receiving a label representative of a location associated with the first user from a server where locational information entered by the first user is stored.

9. The method of claim 1, wherein the first user is the second user, and wherein the message comprises a self-reminder for the first user.

10. A computer-readable storage medium storing computer-executable instructions that, when executed by one or more processors, perform operations comprising:
receiving user information of a first user from a first device operated by the first user, the user information comprising a name of the first user, a user identification (ID) of the first user, a phone number of the first user, locational context information related to the first user, or a combination thereof;
storing the user information of the first user; and
providing data indicative of at least part of the user information of the first user to a second device operated by a second user.

11. The computer-readable storage medium of claim 10, wherein the locational context information related to the first user comprises a plurality of categories of locations associated with the first user.

12. The computer-readable storage medium of claim 10, wherein providing data indicative of at least part of the user information of the first user to a second device operated by a second user comprises providing the locational context information related to the first user to the second device operated by the second user.

13. The computer-readable storage medium of claim 10, further comprising:
receiving, from the second device, a request for information related to the first user,
wherein providing data comprises providing the data in response to receiving the request.

14. A device, comprising:
a memory unit configured to store one or more sets of instructions;
a communication unit configured to transmit and receive data including messages;
a user interface unit configured to receive input form a first user and present information to the first user; and
a processor coupled to the memory unit, the communication unit and the user interface unit, the processor configured to execute the one or more sets of instructions and perform operations comprising:
receiving, through the communication unit, a message from a device operated by a second user, the message including at least one contextual condition defined by the second user;
determining whether the at least one contextual condition is fulfilled; and
providing, through the user interface unit, an indication to the first user to indicate receipt of the message in response to determining the at least one contextual condition is fulfilled.

15. The device of claim 14, wherein the at least one contextual condition comprises a time of day, an event, a location, or a combination thereof.

16. The device of claim 14, wherein the at least one contextual condition comprises a location defined by a geographic point and a radius around the geographic point within which the device needs to be in order for the at least one contextual condition to be fulfilled.

17. The device of claim 16, wherein the at least one contextual condition further comprises a minimum duration for which the device needs to be within the radius around the geographic point in order for the at least one contextual condition to be fulfilled.

18. The device of claim 14, wherein the message comprises text, image, video data, audio data, or a combination thereof.

19. The device of claim 14, wherein the processor is further configured to perform operations comprising:
receiving, through the user interface unit, user information of the first user, the user information comprising a name of the first user, a user identification (ID) of the first user, a phone number of the first user, locational context information related to the first user, or a combination thereof; and
transmitting, through the communication unit, the user information to a server.

20. The device of claim 14, further comprising:
a location determination unit configured to determine an approximate geographic location of the device and output locational data indicative of the approximate geographic location of the device,
wherein the processor is configured to determine whether the at least one contextual condition is fulfilled using the locational data.
